(19) United States
(12) Patent Application Publication
(10) Pub. No.: US 2014/0098172 A1
(43) Pub. Date: Apr. 10, 2014

(54) EXPOSURE APPARATUS AND IMAGE FORMING APPARATUS

(71) Applicant: Fuji Xerox Co., Ltd., Tokyo (JP)

(72) Inventor: Junichi Tanigawa, Mie (JP)

(21) Appl. No.: 13/933,287

(22) Filed: Jul. 2, 2013

(30) Foreign Application Priority Data
Oct. 10, 2012 (JP) 2012-225440

(51) Int. Cl. B41J 2/385

(52) U.S. Cl. CPC G03G 15/04036
USPC 347/118

(57) ABSTRACT

An exposure apparatus includes: a board that is mounted with a light-emitting element; an optical member that images light from the light-emitting element; and a housing that includes: a main body portion; a first protruding portion that protrudes from the main body portion to fix the board and is formed with a liquid crystal polymer flown into from the main body portion when the housing is molded; and a second protruding portion that protrudes from the main body portion to fix the optical member to a different direction from a protruding direction of the first protruding portion and is formed with the liquid crystal polymer flown into from the main body portion when the housing is molded.

### CROSS-REFERENCE TO RELATED APPLICATIONS

This application is based on and claims priority under 35 U.S.C. 119 from Japanese Patent Application No. 2012-225440 filed on Oct. 10, 2012.

### BACKGROUND

The present invention relates to an exposure apparatus and an image forming apparatus.

### SUMMARY

According to an aspect of the invention, an exposure apparatus includes: a board that is mounted with a light-emitting element; an optical member that images light from the light-emitting element; and a housing that includes: a main body portion; a first protruding portion that protrudes from the main body portion to fix the board and is formed with a liquid crystal polymer flown into from the main body portion when the housing is molded; and a second protruding portion that protrudes from the main body portion to fix the optical member to a different direction from a protruding direction of the first protruding portion and is formed with the liquid crystal polymer flown into from the main body portion when the housing is molded.

### BRIEF DESCRIPTION OF THE DRAWINGS

Exemplary embodiment(s) of the present invention will be described in detail based on the following figures, wherein:

FIGS. 1A and 1B illustrate a print head housing and a print head according to the present embodiment and are cross sectional views cut in the direction perpendicular to a drum axis direction;

FIGS. 2A and 2B are cross-sectional views illustrating the pint head housing and the print head according to the present embodiment and cut in the direction which is perpendicular to a direction perpendicular to an axis;

FIG. 3 is a view of a resin flow used to describe a resin flow direction at the time of molding as for the print head housing according to the present embodiment;

FIG. 4 is an enlarged plan view illustrating the print head according to the present embodiment;

FIG. 5 is an exploded perspective view illustrating the print head according to the present embodiment;

FIG. 6 is an exploded perspective view illustrating an image forming apparatus according to the present embodiment; and

FIGS. 7A, 7B, and 7C are a cross-sectional view, a view of a resin flow, and a side view according to a comparison form for the print head housing according to the present embodiment.

### DETAILED DESCRIPTION

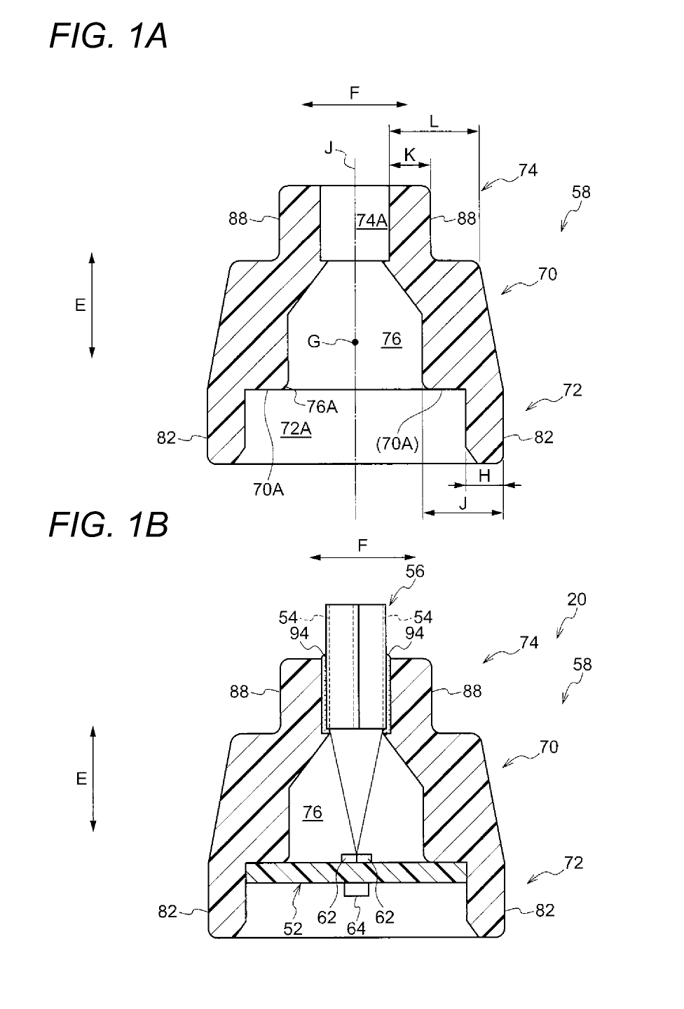

An example of an exposure apparatus and an image forming apparatus according to the present embodiment will be described with reference to FIGS. 1A to 7C. Also, arrow UP illustrated in the drawing illustrates an upper part of the vertical direction.

### (Overall Configuration)

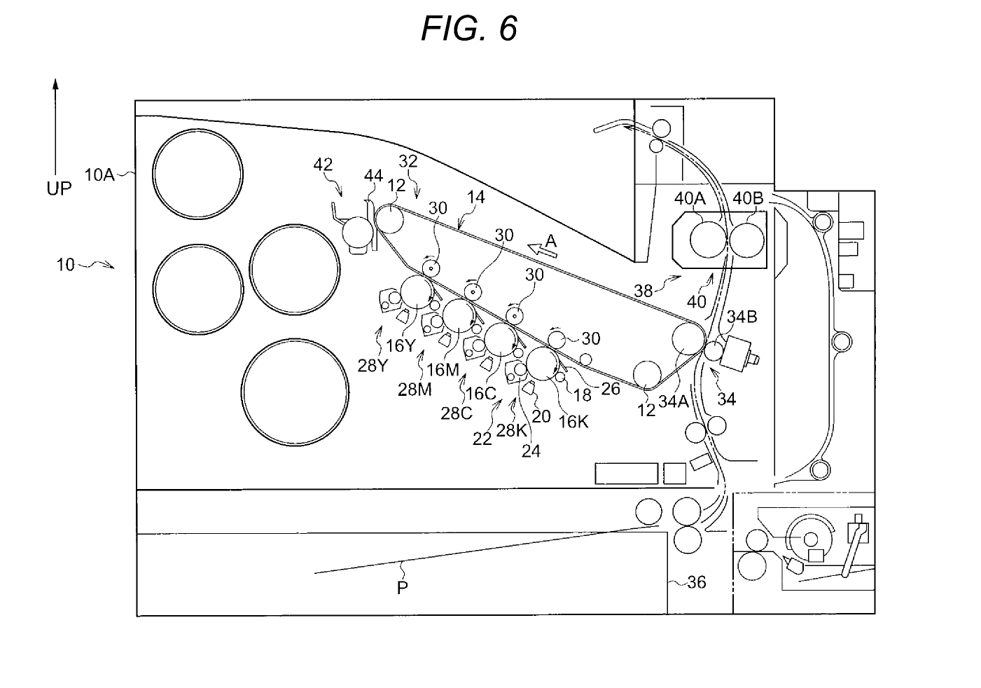

As illustrated in FIG. 6, an apparatus main body 10A of an image forming apparatus 10 is provided with an endless-type intermediate transfer body belt 14 which is stretched on a plurality of rollers 12 and transferred in arrow A direction by a drive of a motor (not illustrated) while constituting a transfer unit 32.

In the image forming apparatus 10, image forming units 28Y, 28M, 28C, 28K corresponding to formation of color images and configured to form toner images corresponding to four colors of yellow (Y), magenta (M), Cyan (C), black (K) are arranged along the lengthwise direction of the intermediate transfer body belt 14 and supported such that the image forming units may be detachable/attachable from/to the apparatus main body 10A.

Also, members provided in each of the colors are denoted by adding alphabets (Y/M/C/K) denoting each color to the end of each symbol. However, especially in a case in which descriptions are made without distinguishing the colors, the alphabets at the end are omitted.

### [Image Forming Unit]

The image forming unit 28 is provided with a photosensitive drum 16 as an example of an image holder rotating clockwise by a driving means formed with a motor and a gear (not illustrated). Also, a charging roller 18 configured to charge the surface of the photosensitive drum 16 equally at a predetermined electric potential is disposed on a circumferential surface of the photosensitive drum 16. Specifically, the charging roller 18 is a conductive roller, the circumferential surface thereof is in contact with the circumferential surface of the photosensitive drum 16, and the axis line direction of the charging roller 18 and the axis line direction of the photosensitive drum 16 are disposed so as to be parallel to each other.

Further, an LED print head 20 (hereinafter, simply denoted as “print head 20”) as an example of the exposure apparatus configured to form an electrostatic latent image by irradiating light on the photosensitive drum 16 is extending in the axis direction of the photosensitive drum 16 on the peripheral surface of the downstream side of the charging roller 18 in the rotation direction of the photosensitive drum 16. The print head 20 is configured to form the electrostatic latent image on the photosensitive drum 16 by irradiating light beams to the photosensitive drum 16 depending on image data. In addition, the print head 20 will be described later in detail.

Furthermore, a developing unit 22 as an example of a developing device configured to form a toner image by developing the electrostatic latent image which is formed on the photosensitive drum 16 by a toner of predetermined color (yellow/magenta/cyan/black) is disposed on the peripheral surface of the downstream side of the print head 20 in the rotation direction of each photosensitive drum.

The developing unit 22 is disposed in the vicinity of the photosensitive drum 16 and provided with a cylindrical developing roller 24 installed rotatably. Developing bias is applied to the developing roller 24 and the charged toner in the developing unit 22 is supposed to be attached to the developing roller 24. Also, the toner attached to the developing roller 24 is transferred to the surface of the photosensitive drum 16 by the rotation of the developing roller 2 and the electrostatic latent image formed on the photosensitive drum 16 is developed as a toner image.

Further, a cleaning blade 26 configured to recover the remaining toner on the photosensitive drum 16 is disposed on the peripheral surface of the downstream side of a transfer roller 30, which will be described later, in the rotation direction of the photosensitive drum 16. The cleaning blade 26 is disposed and installed such that one side thereof is in contact with the photosensitive drum 16 and is supposed to recover the toner remaining on the photosensitive drum 16 without being transferred to the intermediate transfer body belt 14 by the transfer roller 30 or the toner of other colors attached to the photosensitive drum 16 at the time of transfer by scraping.

### [Transfer Unit]

The transfer roller 30 constituting the transfer unit 32 is disposed at a side opposing to the photosensitive drum 16 by sandwiching the intermediate transfer body belt 14 between the transfer roller 30 and the photosensitive drum 16 in the peripheral surface of downstream side of the developing unit 22.

The transfer roller 30 is charged at a predetermined electric potential and rotates counter clockwise, which transfers the intermediate transfer body belt 14 at a predetermined speed and presses the intermediate transfer body belt 14 to the photosensitive drum 16. Accordingly, the transfer roller 30 is supposed to transfer the toner image on the photosensitive drum 16 on the intermediate transfer body belt 14.

Here, the toner images of different colors, which are formed by each image forming unit 28 are transferred on the intermediate transfer body belt 14 such that the toner images are superimposed on one another. Accordingly, colored toner images are formed on the intermediate transfer body belt 14. Also, in the present embodiment, a transferred toner image in which toner images of four colors have been superimposed is called as “final toner image”.

In contrast, a transfer device 34 formed with two rollers 34A, 34B which face each other is disposed at the downstream side of the photosensitive drum 16 of each color in the transfer direction of the intermediate transfer body belt 14. The final toner image formed on the intermediate transfer body belt 14 is transferred to a sheet member P which is extracted from a paper tray 36 provided at the lower section of the image forming apparatus 10 and transferred between the rollers 34A, 34B.

Meanwhile, a cleaner 42 configured to recover the toner remaining on the intermediate transfer body belt 14 without being transferred to the sheet member P by the transfer device 34 is provided at the downstream side of the transfer device 34 in the transfer direction of the intermediate transfer body belt 14. In the cleaner 42, a blade 44 is provided so as to be in contact with the intermediate transfer body belt 14 and the remaining toner is recovered by being scraped.

### [Fixing Unit]

Also, a fixing unit 38 is provided on the transfer path of the sheet member P where the final toner image is transferred. The fixing unit 38 is provided with a fixing device 40 configured by including a heat roller 40A and a pressure roller 40B. The sheet member P transferred to the fixing device 40 is sandwiched and transferred by the heat roller 40A and the pressure roller 40B. Therefore, the toner on the sheet member P is clamped on the sheet member P while melting so as to be fixed on the sheet member P.

### (Application of Entire Configuration)

In the image forming apparatus 10, an image is formed as follows.

Firstly, charging roller 18 negatively charges the surface of the photosensitive drum 16 equally at a predetermined charging part electric potential. Also, exposure is performed by the print head 20 such that image part on the charged photosensitive drum 16 is charged at a predetermined exposure part electric potential; therefore, the electrostatic latent image is formed on the photosensitive drum 16.

When the electrostatic latent image on the rotating photosensitive drum 16 passes the developing roller 24 provided in the developing unit 22, the toner of a developer is attached to the electrostatic latent image and the electrostatic latent image is visualized as a toner image.

Visualized toner image of each color is sequentially transferred to the intermediate transfer body belt 14 by electrostatic force of the transfer roller 30 and the colored final toner image is formed on the intermediate transfer body belt 14.

The final toner image is sent between the rollers 34A, 34B provided for the transfer device 34. The final toner image is transferred to the sheet member P which has been extracted from the paper tray 36 and then sent between the rollers 34A, 34B.

Also, the toner image transferred on the sheet member P is fixed on the sheet member P by the fixing device 40 and the sheet member P is discharged out of the device.

### (Configuration of Principal Part)

Next, the print head 20 will be described.

The print head 20 is a long shape extending in a direction and disposed so as to extend along a rotation axis direction (arrow D direction illustrated in each drawing: hereinafter, simply denoted as “drum axis direction”) of the photosensitive drum 16 (see FIG. 6) in a state in which the print head 20 is attached to the apparatus main body 10A.

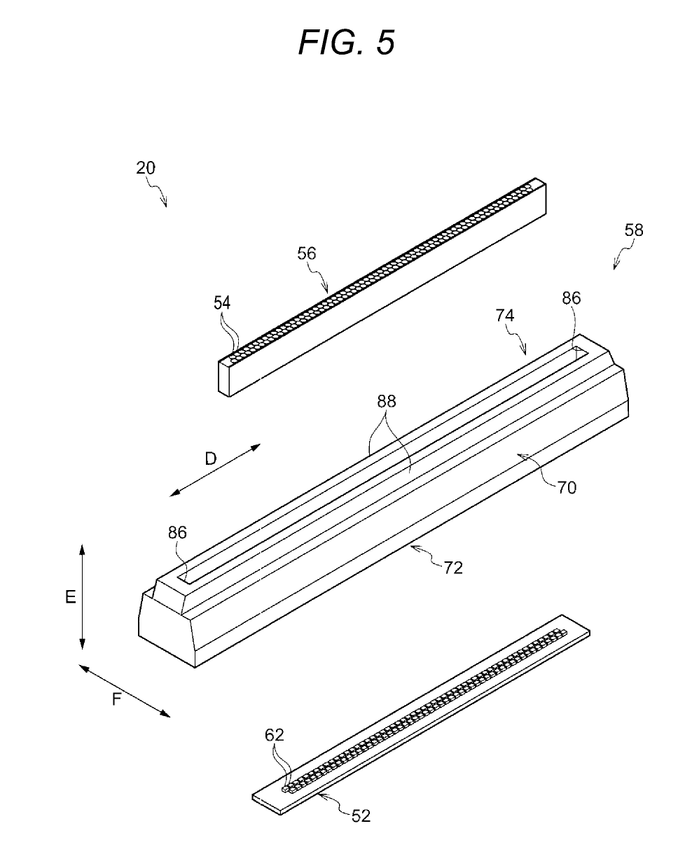

The print head 20 is provided with a print circuit board 52 as an example of a board where a light-emitting diode array 62 as an example of a light-emitting element is mounted as illustrated in FIG. 5. Also, the print head 20 includes: a lens array 56 as an example of an optical member where a plurality of cylindrical rod lenses 54 which light emitted by light emitting points (“LEDs”) of the light-emitting diode array 62 transmits are formed and a housing 58 configured to fix the print circuit board 52 and the lens array 56.

In addition, in a case where a direction is denoted in the following descriptions, the direction is denoted in a state where the print head 20 is attached to the apparatus main body 10A.

### [Print Circuit Board]

The print circuit board 52 extends in the drum axis direction. On one surface of the print circuit board 52, the light-emitting diode array 62 provided with a plurality (for example, 128) of light-emitting diodes (LEDs) rectilinearly is mounted a plurality of times in a zigzag manner as illustrated in FIGS. 1B and 5. On the contrary to this, on the other surface of the print circuit board 52, an electronic component 62 configured to control the light-emitting diode array 62 is mounted.

### [Lens Array]

The lens array 56 is a rectangular parallelepiped shape extending in the drum axis direction. In the lens array 56, the plurality of rod lenses 54 which the light emitted from the light-emitting diode of the light-emitting array 62 transmits are arranged in a zigzag manner. Accordingly, the light which is emitted from the light-emitting points of the light-emitting diode array 52 and then transmits the rod lenses 54 is supposed to form a image on the photosensitive drum 16 (an example of an object).

### [Housing]

The housing 58 extends in the drum axis and is formed by an injection molding using a liquid crystal polymer material. Also, the cross section of the housing 58 intersecting with the drum axis direction is symmetric with respect to line J which extends in the optical axis direction (direction of arrow E illustrated in each drawing: Hereinafter, it will be simply denoted as “lens axis direction”) of the rod lenses 54 through a center of gravity G of the housing 58 as illustrated in FIG. 1A.

Also, the housing 58 includes: a board fixing portion 72 configured to fix the print circuit board 52; a lens fixing portion 74 configured to fix the lens array 56; and a main body portion 70 interposed between the board fixing portion 72 and the lens fixing portion 74 in the lens axis.

The rod lense 54 of the lens array 56 and the light-emitting diode array 62 mounted on a surface of the print circuit board 52 are arranged to face each other in the lens axis direction as illustrated in FIG. 1B in a state in which the lens array 56 and the print circuit board 52 are fixed to the housing 58.

### [Main Body Portion]

The main body portion 70 extends in the drum axis direction and the cross section of the main body portion 70, which intersects with the drum axis direction, is a trapezoid shape of which the width at the lens fixing portion 74 side is narrower than the width at the board fixing portion 72 side as illustrated in FIGS. 1A and 5.

Also, in the main body portion 70, a through hole 76 through which the light emitted from the light-emitting diode array 62 toward the rod lenses 54 passes and which is long in the drum axis direction, as illustrated in FIGS. 1A and 1B, is formed.

Further, in the main body portion 70, an end surface 70A formed so as to surround an opening edge 76A at the board fixing portion 72 side of the through hole 76 comes into contact with a board surface of the outer peripheral side of the print circuit board 52.

Furthermore, one end side of the main body portion 70 in the drum axis direction is a gate section 78 where a melted resin material (liquid crystal polymer) is flown into a hollow part (cavity) of a mold (not illustrated) when forming the housing 58 by the injection molding.

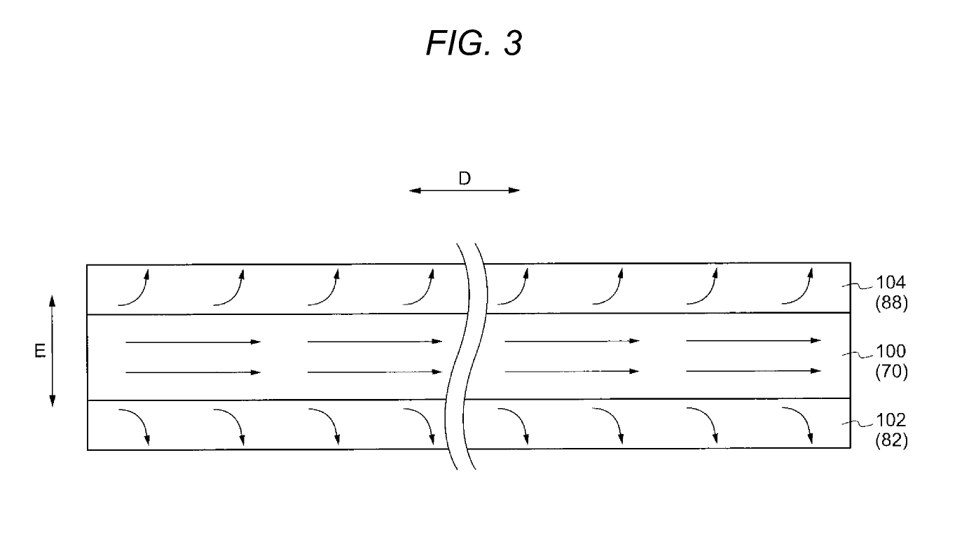

In a case of injection molding with this configuration, the melted liquid crystal polymer passes through a runner 84 and a gate and is flown into (see arrows in FIG. 3) a hollow part 100 (see FIG. 3) of the mold for forming the main body portion 70 in the drum axis direction (an example of one direction)

### [Board Fixing Portion]

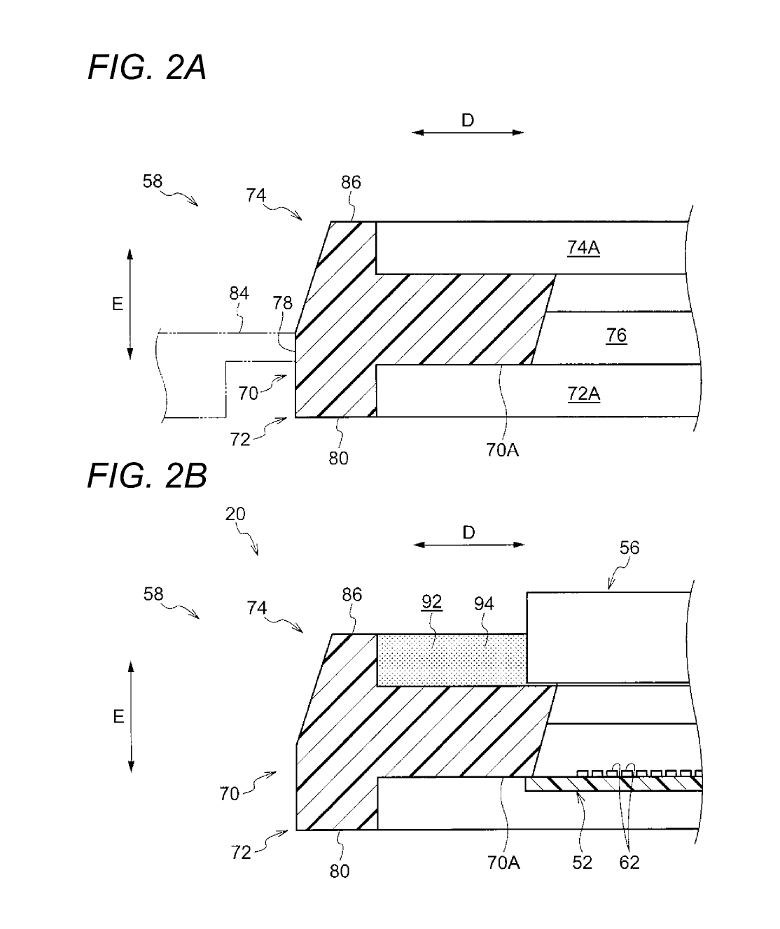

The board fixing portion 72 is a frame extending in the drum axis direction. In the board fixing portion 72, a hollow part 72A (see FIGS. 1A and 2A) in which the print circuit board 52 is disposed and with which the through hole 76 is connected is formed. The hollow part 72A (see FIGS. 1A and 2A) is formed to be surrounded by protrusions 80 and protrusions 82, which are described later, in the direction perpendicular to the drum axis direction and the lens axis direction (arrow F direction illustrated in each drawing: hereinafter, simply denoted as “direction perpendicular to the axis”) and in the lens axis direction.

Specifically, the board fixing portion 72 is provided with the protrusions 80 protruding toward the lens axis direction (downward direction in the drawing) at each of both ends (only one side is illustrated in FIGS. 2A and 2B) of the main body portion 70 in the drum axis direction as illustrated in FIG. 2A. Also, the board fixing portion 72 has the protrusions 82 as an example of a first protruding portion protruding toward the lens axis direction (downward direction in the drawing) at each of both end portion sides in the direction perpendicular to the axis of the main body portion 70 as illustrated in FIG. 1A. Each of the both end portions of the protrusions 82 in the drum axis direction is connected to each of the both end portions of the protrusions 80 (See, e.g., FIGS. 2A and 2B) in the direction perpendicular to the axis each other.

Also, the dimension of the width (dimension H in the drawing) of the protrusion 88 in the direction perpendicular to the axis is smaller than that (dimension J in the drawing) of the main body portion 70 of the bottom end side of the protrusion 82 in the direction perpendicular to the axis. The surface by step difference between the protrusion 82 and the main body portion 70 is the above-described end surface 70A.

In a case of injection molding with this configuration, the liquid crystal polymer flown into the hollow part 100 of the mold for forming the main body portion 70 is also flown into (see arrows in FIG. 3) a hollow part 102 (see FIG. 3) of the mold for forming the protrusion 82.

### [Lens Fixing Portion]

The lens fixing portion 74 is a frame extending in the drum axis direction. In the lens fixing portion 74, a groove 74A of which the lens axis direction is open and where the lens array 56 is disposed is formed.

Specifically, the lens fixing portion 74 is provided with protrusions 86 each protruding toward the lens axis direction (upward direction in the drawing) at each of both end sides (only one side is illustrated in FIGS. 2A and 2B) of the main body portion 70 in the drum axis direction as illustrated in FIG. 2A. Also, the lens fixing portion 74 is provided with protrusions 88, as an example of a second protruding portion, each protruding toward the lens axis direction (upward direction in the drawing) from the main body portion 70 such that the groove 74A is formed as illustrated in FIG. 1A. Each of both end portions of the protrusions 88 in the drum axis direction is connected to each of both end portions of the protrusions 86 (see FIGS. 2A and 2B) in the direction perpendicular to the axis

Also, the dimension of the width (dimension K in the drawing) of the protrusion 88 in the direction perpendicular to the axis is smaller than that (dimension L in the drawing) of the main body portion 70 of the bottom end of the protrusion 88 in the direction perpendicular to the axis. Further in the present embodiment, the dimension of K is the same as the above-described dimension of H.

In a case of injection molding with this configuration, the liquid crystal polymer flown into the hollow part 100 of the mold for forming the main body portion 70 is also flown into (See arrows in FIG. 3) a hollow part 104 (See, e.g., FIG. 3) of the mold for forming the protrusion 88 along the drum direction.

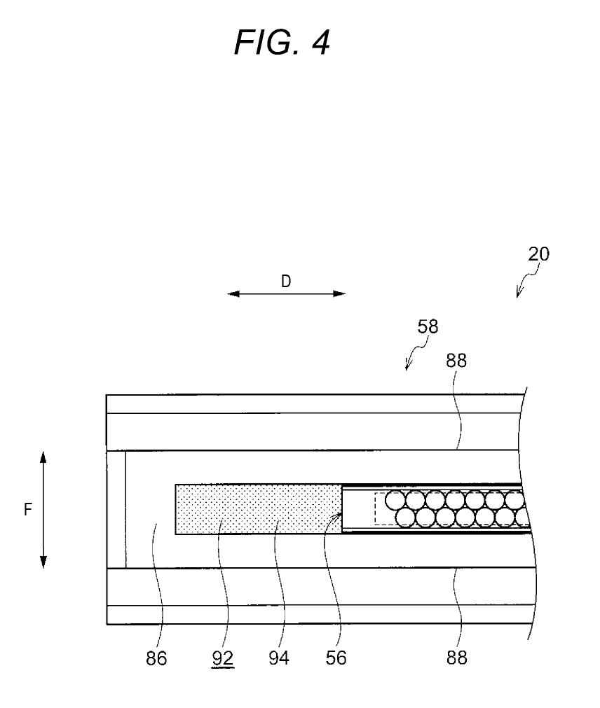

Meanwhile, the end portion of the lens array 56 in the drum axis direction, which is attached to the housing 58, and the protrusion 86 are separated in the drum axis direction as illustrated in FIGS. 2B and 4, thereby forming a separation section 92 (only one side is illustrated in FIGS. 2A, 2B and 4). The separation section 92 is a rectangle shape extending toward the drum axis direction when viewed from the lens axis direction. The front end portion of a nozzle (illustration omitted) used to apply a sealant 94 sealing the gap between the housing 58 and the lens array 56 is inserted to the separation section 92. Also, the application location of the sealant 94 will be described together with the operation of a main part, which will be described later.

### (Operation of Main Part)

Next, a process of attaching the lens array 56 and the print circuit board 52 to the housing 58 (attachment work) and a process of forming the housing 58 by injection molding (molding work) will be described. Also, after the attachment work is described, the molding work will be described.

### [Attachment Work]

Firstly, the lens array 56 is moved toward the lens axis direction with respect to the housing 58 such that the lens array 56 is inserted to a pair of protrusions 88 (see FIGS. 1A, 1B, 2A and 2B). In a state in which the lens array 56 is inserted to the protrusions 88, the lens array 56 is fixed to the protrusions 88 using a fixing member which is not illustrated (lens attachment process).

Next, the front end portion of the nozzle (not illustrated) for applying the sealant 94 is inserted to separation section 92 at one side and the sealant is discharged from the nozzle. Accordingly, one end of the lens array 56 and the housing 58 are sealed. When the discharge of the sealant 94 is stabilized, the front end portion of the nozzle is moved along the boundary of the side surface of the lens array 56 and the protrusion 88 at one side toward the separation section 92 at the other side. Accordingly, the gap between the side surface and the protrusion 88 at one side, in which the sealant 92 is applied, is sealed.

Also, by the sealant 94 discharged from the nozzle which reaches the separation section 92 on the other side, the other end portion of the lens array 56 and the housing 58 are sealed. Further, the front end portion of the nozzle is moved along the boundary of the side surface of the lens array 56 and the protrusion 88 at the other side toward the separation section 92 at one side. Accordingly, the gap between the side surface and the protrusion 88 on the other side, in which the sealant 94 is applied, is sealed. As described above, the entire periphery of the lens array 56 and the housing 58 are sealed by the sealant 94 (sealing process 1).

Next, the print circuit board 52 is moved in the lens axis direction with respect to the housing 58 such that the board surface of the outer peripheral side of the print circuit board 52 and the end surface 70A are in contact with each other (See, e.g., FIGS. 1B and 2B). In a state in which the print circuit board 52 and the end surface 70A are in contact with each other, the print circuit board 52 is fixed to the protrusion 82 using the fixing member which is not illustrated (board attachment process).

Then, the front end portion of the nozzle (not illustrated) for applying the sealant 94 is moved and applies the sealant 94 throughout the housing 58 and the print circuit board 52 (sealing process 2).

As described above, the lens array 56 and the print circuit board 52 are attached to the housing 58.

### [Molding Work]

When the housing 58 is formed by injection molding, the melted liquid crystal polymer passes through the runner 84 and the gate section 78 (see FIG. 2A) and is flown into the hollow part 100 of the mold for forming the main body portion 70 along the drum axis direction as illustrated in FIG. 3 (See arrows in the drawing). Accordingly, the molecules constituting the liquid crystal polymer which fills the hollow part 100 are arranged along the drum axis direction (molecular orientation).

Also, the liquid crystal polymer flown into the hollow part 100 along the drum axis is flown into the hollow part 102 of the mold for forming the protrusion 82 (See arrows in the drawing). Accordingly, the molecules constituting the liquid crystal polymer which fills the hollow part 102 are arranged along the direction inclined toward the lens axis direction with respect to the drum axis direction (molecular orientation).

Likewise, the liquid crystal polymer flown into the hollow part 100 along the drum axis is flown into the hollow part 104 of the mold for forming the protrusion 88 (see arrows in the drawing). Accordingly, the molecules constituting the liquid crystal polymer which fills the hollow part 104 are arranged along the direction inclined toward the lens axis direction with respect to the drum axis direction (molecular orientation).

Also, the liquid crystal polymer flown into the hollow part 100 is flown into to fill the hollow parts (illustration omitted) of the mold for forming the protrusion 80 and the protrusion 86.

After the mold is filled with the liquid crystal, the liquid crystal is cooled and the molten liquid crystal polymer solidifies. Also, by removing the liquid crystal polymer (housing 58), which has been filled to and solidified, from the mold, the housing 58 may be obtained. Here, conventionally, when the housing 58 is removed from the mold, mold shrinkage (shrinkage which occurs in the housing 58 when the housing 58 is removed from the mold and then cooled to the room temperature) occurs. By this mold shrinkage, conventionally, the housing 58 is bent when viewed from the direction perpendicular to the axis.

However, in the present invention, the bending is suppressed as follows.

That is, as described above, in the main body portion 70, the molecules constituting the liquid crystal polymer are arranged along the drum axis direction (see FIG. 3). Thus, the shrinkage amount of the main body portion 70 in the drum axis direction is small when compared to a case in which the molecules are arranged along the lens axis direction.

Meanwhile, in the protrusion 82, the molecules constituting the liquid crystal are arranged along the direction inclined toward the lens axis direction with respect to the drum axis direction (see FIG. 3). Thus, the shrinkage amount of the protrusion 82 in the drum axis direction is large when compared to a case in which the molecules are arranged along the drum axis direction. Therefore, in the housing 58, when it is viewed from the direction perpendicular to the axis, a bending force which causes one side (upper side in FIG. 3) to be convex occurs.

On the contrary to this, in the protrusion 88, the molecules constituting the liquid crystal polymer are arranged along the direction inclined to the lens axis with respect to the drum axis direction like protrusion 82 (see FIG. 3). Thus, the shrinkage amount of the protrusion 88 in the drum axis direction is large when compared to a case in which the molecules are arranged along the drum axis direction. Therefore, in the housing 58, when it is viewed from the direction perpendicular to the axis, a bending force which causes the other side (lower side in FIG. 3) to be convex is exerted.

In this manner, in the housing 58, when it is viewed from the direction perpendicular to the axis, a bending force which causes one side to be convex and a bending force which causes the other side to be convex are exerted. Thus, a force at one side weakens a force at the other side, thereby suppressing the bending of the housing 58 when viewed from the direction perpendicular to the axis.

Also, the direction (orientation direction) where the molecules are arranged may be checked when a member after molding is sliced thinly and then the sliced member is seen by, for example, a polarizing microscope, transmission electron microscope.

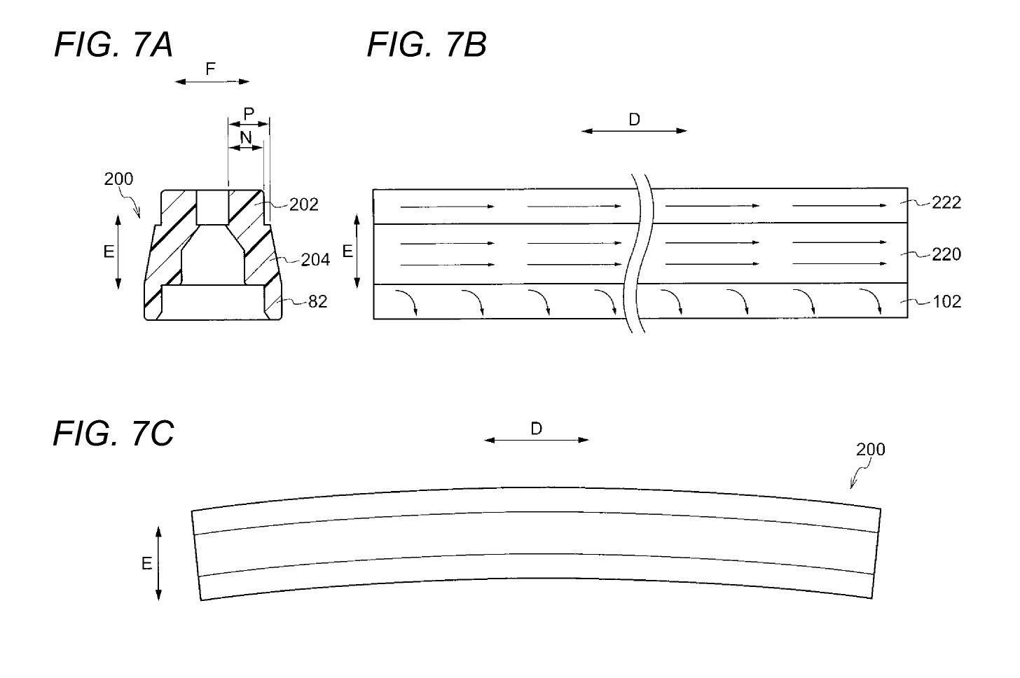

Here, as for a comparison form of the present exemplary embodiment, a housing 200 will be described. A cross section of the housing 200 is illustrated in FIG. 7A, a flow of resin (liquid crystal polymer) within a mold when forming the housing 200 is illustrated in FIG. 7B, and a shape of the housing 200 after molding is exaggeratively illustrated in FIG. 7C.

The dimension (dimension N in the drawing) of the width of a protrusion 202 configured to fix the lens array 56 in the direction perpendicular to the axis is a bit smaller than the dimension (dimension P in the drawing) of the width of a main body portion 204 of the bottom end of the protrusion 202 in the direction perpendicular to the axis as illustrated in FIG. 7A. That is, the ratio of dimension N to dimension P becomes larger than the ratio of dimension K to dimension L illustrated in FIGS. 1A and 1B. Also, another shape of the housing 200 is the same as that of the housing 58 according to the present embodiment.

When the housing 200 is molded, melted liquid crystal polymer passes through the runner 84 and the gate (see FIG. 2A) and is flown into a cavity part 220 of the mold for forming a main body portion 204 along the drum axis direction (see arrows in the drawing). Accordingly, the molecules constituting the liquid crystal which fills the cavity part 220 are arranged along the drum axis direction.

In the same manner, melted liquid crystal polymer is flown into a cavity part 222 of the mold for forming the protrusion 202 along the drum axis direction (See arrows in the drawing). Accordingly, the molecules constituting the liquid crystal which fills the cavity part 222 are arranged along the drum axis direction. This is because the degree of causing dimension N of the protrusion 202 to be smaller than dimension P of the main body portion 204 is small (see FIG. 7A).

Also, as described above, the liquid crystal polymer flown into the cavity part 220 along the drum axis direction is flown into the cavity part 102 of the mold for forming the protrusion 82 (See arrows in the drawing). Accordingly, the molecules constituting the liquid crystal polymer which fills the cavity part 102 are arranged along the direction inclined to the lens axis direction with respect to the drum axis direction.

As described above, the shrinkage amount of the protrusion 82 in the drum axis direction is large when compared to a case in which the molecules are arranged along the drum axis direction. Thus, in the housing 200, a bending force which causes the one side (upper side in the drawing) to be convex is exerted when seen from the direction perpendicular to the axis. However, in the protrusion 202, the molecules constituting the liquid crystal polymer are arranged along the drum axis direction (see FIG. 7B). Thus, a force suppressing the bending force causing the one side to be convex does not occur and the one side of the housing 200 is bent to be convex when it is viewed from the direction perpendicular to the axis as illustrated in FIG. 7C.

As it may be seen in a comparison with the housing 200, as for the protrusion 88 of the housing 58 according to the present embodiment, the molecules constituting the liquid crystal polymer are arranged along the direction inclined toward the lens axis direction with respect to the drum axis direction. Thus, as described above, in the housing 58, when viewed from the direction perpendicular to the axis, a bending force which causes one side to be convex and a bending force which causes the other side to be convex are exerted. Therefore, in the housing 58 according to the present exemplary embodiment, a force at one side weakens a force at the other side, thereby suppressing the bending of the housing 58 when viewed from the direction perpendicular to the axis.

Also, since the bending of the housing 58 is suppressed when the housing 58 is molded, poor exposure of the print head 20 caused by the bending occurring in the housing 58 in molding is suppressed, thereby enhancing the quality of exposure.

Further, the main body portion 70 is formed by a flow of liquid crystal polymer toward the drum axis direction in molding. Thus, deformation of the housing 58 due to mold shrinkage of the main body portion 70 is suppressed when compared to a case in which the main body portion is formed by a flow of liquid crystal polymer toward multi-directions from a plurality of gates when being molded.

Furthermore, although the housing 58 is deformed when the housing 58 is molded, the deformation is suppressed, thereby suppressing poor exposure of the print head 20 due to the deformation when the housing 58 is molded.

In addition, since poor exposure of the print head 20 is suppressed, quality deterioration of the output image of the image forming apparatus 10 due to poor exposure of the print head 20 is suppressed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

For example, although the print circuit board 52 is attached to the housing 58 after the lens array 56 is attached to the housing 58 in the above-described exemplary embodiment, the order may be reversed or the lens array 56 and the print circuit board 52 may be attached to the housing 58 simultaneously.

Further, in the above-described exemplary embodiment, the lens array 56 is attached to the housing 58 (lens attachment process), the sealant 94 is applied throughout the lens array 56 and the housing 58 (sealing process 1), then the print circuit board 52 is attached to the housing 58 (board attachment process), and the sealant 94 is applied throughout the print circuit board 52 and the housing 58 (sealing process 2). That is, the lens attachment process and the sealing process 1 and the board attachment process and the sealing process 2 performed in this order is described. However, it may be (1) a procedure of the lens attachment process and the board attachment process and the sealing process 1 and the sealing process 2 or (2) a procedure of the lens attachment process and the board attachment process and the sealing process 2 and the sealing process 1. Also, in above-described (1) and (2) procedures, the order of the lens attachment process and board attachment process may be reversed.

What is claimed is:

1. An exposure apparatus comprising:
a board that is mounted with a light-emitting element;
an optical member that images light from the light-emitting element; and
a housing that includes:
a main body portion;
a first protruding portion that protrudes from the main body portion to fix the board and is formed with a liquid crystal polymer flown into from the main body portion when the housing is molded; and
a second protruding portion that protrudes from the main body portion to fix the optical member to a different direction from a protruding direction of the first protruding portion and is formed with the liquid crystal polymer flown into from the main body portion when the housing is molded.

2. The exposure apparatus of claim 1, wherein the main body portion is formed with the liquid crystal polymer which flows toward one direction when the housing is molded.

3. An exposure apparatus comprising:
a board that is mounted with a light-emitting element
an optical member that images light from the light-emitting element; and
a housing that includes:
a main body portion formed with molecules constituting a liquid crystal polymer are arranged along one direction;
a first protruding portion that protrudes from the main body portion to fix the board and is formed with the molecules which constitute the liquid crystal polymer and are arranged along a direction inclined with respect to said one direction; and
a second protruding portion that protrudes from the main body portion to fix the optical member to a different direction from a protruding direction of the first protruding portion and is formed with the molecules which constitute the liquid crystal polymer and are arranged along a direction inclined with respect to said one direction.

4. An image forming apparatus comprising:
an image holder;
the exposure apparatus of claim 1, that forms an electrostatic latent image by exposing the image holder; and
a developing device that develops the electrostatic latent image of the image holder formed by the exposure apparatus.
